(19) United States
(12) Patent Application Publication
(10) Pub. No.: US 2016/0345618 A1
(43) Pub. Date: Dec. 1, 2016

(54) Mono and Di-Glyceride Esters of Omega-3 Fatty Acid Emulsions

(71) Applicant: MyCell Technologies, LLC, Montvale, NJ (US)

(72) Inventor: Volker Berl, New York, NY (US)

(21) Appl. No.: 15/163,524

(22) Filed: May 24, 2016

Related U.S. Application Data
(60) Provisional application No. 62/166,049, filed on May 25, 2015.

(51) Int. Cl. A23L 33/12; A23L 35/00; A23L 2/52

(52) U.S. Cl. CPC A23L 33/12; A23L 2/52; A23L 35/10; A23V 2002/00

(57) ABSTRACT

In one embodiment, the present application discloses an aqueous omega-3 fatty acid composition comprising: a) water; b) a high HLB non-ionic emulsifier with HLB>10; and c) a marine oil, an algae derived oil or a vegetable oil high in omega-3 fatty acid comprising a total glycerides comprising a monoglyceride (MG), a diglyceride (DG) and a triglyceride (TG) of the omega-3 fatty acid, wherein the TG of the omega-3 fatty acid content in the composition is less than 80% of the total glycerides.

### RELATED APPLICATION

This application claims the benefit of U.S. Provisional Application No. 62/166,049 filed on May 25, 2015, which is incorporated herein in its entirety.

### BACKGROUND OF THE INVENTION

Methods of solubilizing bioactive compounds using oil-in-water microemulsions with the aim of achieving clear (that is, translucid, essentially clear with NTU values of <150) formulations of lipophilic bioactives in liquid matrices, relying for the most part on nonionic high HLB synthetic emulsifiers, have been broadly studied in recent years by a variety of entities, such as Eastman-Kodak (TPGS, U.S. Pat. No. 2,680,749), Zymes (PTS, US2008/0254188), Solublend (Solutol HS-15, Cremophor/Kolliphor RH-40, WO2010/151816), Virun (TPGS, U.S. Pat. No. 8,282,977), Aquanova (Polysorbates (tween 20, tween 80 etc. . . . ), Nutralease (tween 20, 60 and 80, Prof. Nissim Garti, US20030232095), and Applicant's U.S. Pat. No. 8,927,043, as representative methods. Among a long list of bioactives compatible with, and requiring such solubilizing approaches (including, for example, PEG-derivatives of Vitamin E, such as tocopherol and tocotrienol-derived surfactants, where the Vitamin E group is attached to another group, such as a polyethylene glycol (PEG) group, tocopherol-derived surfactants such as polyalkylene glycol derivatives of tocopherol, polyethylene glycol (PEG) derivatives of tocopherol, tocopherol polyethylene glycol diesters (TPGD) including tocopherol polyethylene glycol succinate (TPGS), TPGS analogs, homologs and derivatives; tocopherol sebacate polyethylene glycol, tocopherol dodecanedioate polyethylene glycol, tocopherol suberate polyethylene glycol, tocopherol azelaate polyethylene glycol, tocopherol citraconate polyethylene glycol, tocopherol methylcitraconate polyethylene glycol, tocopherol itaconate polyethylene glycol, tocopherol maleate polyethylene glycol, tocopherol glutarate polyethylene glycol, tocopherol glutaconate polyethylene glycol and tocopherol phthalate polyethylene glycol. In another example, the TPGD surfactant is a tocopherol polyethylene glycol succinate (TPGS) such as TPGS-500, TPGS-750 and TPGS-1000. Presently, the bioactives with significant commercial interest for such novel solubilization approaches are omega-3 fatty acids EPA and DHA, coenzyme Q10, ubiquinol and resveratrol.

The interest in such clear emulsions stems from the opportunity to deliver those water insoluble bioactives in foods, such as clear beverages, clear liquid nutritional supplements, gelatins and other liquid foods, or to use the emulsions as a mechanism for introducing the bioactives in other manufacturing processes, such as meat processing, cereal/granola processing, etc.

Before the advent of the above referenced solubilization approaches, these liquid finished product categories traditionally could not be fortified with those bioactives for a variety of reasons, the main ones being the lack of clarity, and the lack of emulsion stability. The large particle sizes, usually well above 300 nm to several microns, generated by more classic emulsion systems, such as e.g., hydrocolloids based on modified food starches (OSA starches), (DSM, US20120093998A1), lecithin or protein (e.g., caseinate) based formulations (DSM, ropufa emulsion, US20120276248A1), among others, are often times not suitable for commercial applications as their milky appearance in finished products can be unappealing to consumers. These emulsions also have commercially insufficient shelf life due to clouding, precipitation, crystallization, and/or oiling or ringing (e.g., through Oswald ripening processes), which have precluded the applicability of such classic food emulsions to liquid food categories.

On the other hand, approaches using food grade high HLB emulsifiers have been found to successfully deliver clear (or translucid) and long-term stable emulsions that are compatible with clear applications and provide, for specifically designed applications and finished product matrices. Nonetheless, with the required emulsion stability for commercially preferred shelf-life in excess of one year, their adoption into the marketplace has met with several technical and commercial obstacles. These obstacles mostly stem from the required use of a significant amount of the above mentioned emulsifiers (and occasional co-emulsifiers) to achieve clarity and long term emulsion stability. While aqueous formulations using different bioactives with different solubilizers can vary widely with regard to the needed stoichiometries between the water phase (that can occasionally contain an alcohol or polyol co-solvent), emulsifier (that may occasionally include a co-emulsifier) and bioactive, generally at least 2 to 3 equivalents by weight of the solubilizer with regard to the bioactive are needed to achieve clarity. In some examples co-solubilizers (e.g., medium chain triglycerides, certain diglicyerides or monoglycerides, etc.) or other additives are used to optimize the emulsifier-to-bioactive ratio, with limited impact and success.

The need for relatively high amounts of emulsifiers usually leads to a clear stable emulsion that by necessity are quite diluted with water, resulting in emulsions in which the bioactive (such as omega-3 EPA/DHA) is limited to amounts not exceeding 5-10 percent of the finished emulsion. Typical commercially viable, stable and clear aqueous emulsions have water:emulsifier:bioactive w/w percentage ranges of 55-65%:20-35%:5-10%, although sometimes there are claims that these can be in much broader proportions in the above cited references. These required ranges representing the state-of-the-art result in a variety of technical and commercial obstacles.

a) Technical obstacles—Taste: Use of the above mentioned emulsifiers can have a negative impact on taste. All synthetic emulsifiers have a bitter, stingy, earthy or chemical taste, and after taste that needs to be masked or overpowered by an appropriate flavoring concept in the finished food application. This adds development time to achieve a finished product, as well as cost for the flavoring and masking. While all emulsifiers are more or less affected by their taste contribution, the bitterness and “bite” is most pronounced when using polysorbates.

b) Commercial Obstacles—Cost: From a raw material cost perspective, the emulsifier—relative to the cost of the bioactive in the emulsion—is often the most expensive ingredient in the emulsion. This is especially true for vitamin E-derived solubilizers such as TPGS and PTS. Moreover, the need for a relatively high amount of water to achieve a stable emulsion means a low emulsion concentration when producing such solutions in standardized batching or continuous manufacturing processing operations. Shipping mostly water, instead of the valuable bioactive, adds significant additional cost to the formulated bioactive. Attempting to solubilize a comparatively cheap bioactive (e.g., omega-3 fatty acids, or conjugated linoleic acids (CLA)) using the above technologies can easily multiply by a factor of 5 to 10 the cost of the bioactive delivered in its emulsified form.

An additional commercial obstacle pertaining specifically to the commercialization of emulsified omega-3 fatty acid ingredients has been the intrinsic oxidative instability, and consequently, strong sensory challenges. These intrinsic properties of omega-3s require a suitable and robust stabilization/protection approach at room temperature in order to achieve a viable commercial ingredient that can easily be introduced and handled in most existing food manufacturing processes. This approach must also impart a long shelf life to finished foods, such as beverages, without causing the development of sensory off-notes during storage of the finished products. U.S. Pat. No. 8,927,043 discloses how these goals can be achieved.

Consequently, due to the challenging price points that need to be absorbed by the finished product, or passed on to the consumer as a premium, and due to the sensory challenges fundamental to the omega-3s EPA and DHA, it is not surprising that emulsion compositions have been limited so far in their commercial applications to beverages and other clear solutions in water.

### DETAILED DESCRIPTION OF THE INVENTION

The Applicant recognized that there is a need for a method for the optimization of the above described emulsion systems, with the aims of raw material cost reduction as well as increased manufacturing productivity. Unlike all prior efforts in this field, the present invention discloses clear and stable compositions of omega-3 fatty acids EPA and DHA of exceptionally high omega-3 content, low emulsifier content, and low water content, thereby leading to a significant cost reduction of emulsified omega-3 fatty acids over conventional emulsification systems delivering bulk omega-3 oils.

One approach to achieve these goals is described as follows: Marine oils contain an abundance of \acute{ω}-3 PUFAs and have traditionally been used as the raw materials for preparation of highly purified \acute{ω}-3 PUFA concentrates. Because of the complex fatty acid composition along with many other impurities found in marine oils, \acute{ω}-3 PUFAs in highly purified form cannot be prepared by any single fractionation method. Usually, a combination of methods is needed, which depends on the fatty acid composition of the starting oil and the desired concentration and purity of the \acute{ω}-3 PUFA in the final product.

Methods for the concentration of \acute{ω}-3 PUFAs are numerous, but only a few are suitable for large-scale production. The available methods include chromatography, fractional or molecular distillation, enzymatic splitting, low-temperature crystallization, supercritical fluid extraction, and urea complexation (urea clathrate adduct formation). There is a wealth of literature and art describing the advantages and disadvantages of each individual process and their respective contributions towards achieving highly refined, highly concentrated omega-3 oil. However, this is not the goal of this invention disclosure.

One purification step, which is particularly relevant to the feasibility of the present invention, converts the natural triglyceride (TG) oils into their more volatile methyl esters (MEs) or ethyl esters (EEs), which allows for their fractional and molecular distillation under mild, reduced pressures (0.1-1.0 mmHg). This process step is particularly important as it allows the separation of fatty acids with different chain lengths, and thus a significant separation and concentration of EPA and DHA. It also eliminates potential toxic metals from the distilled oils. Furthermore, the method serves to remove saturated fats, which cannot be achieved with methods that rely on concentration of the natural TG form alone. This purification step, therefore, is an integral part of a great number of commercial marine oil refining processes, offering highly refined fish oil concentrates, as it effectively concentrates the omega-3 content from 20-30% to 55-65%.

While EEs are a commercial source of highly refined omega-3 fatty acids, a large portion of the refined EEs is converted back into the more natural TG form. This is for the most part achieved via enzymatic technology, especially microbial lipases, as they are known to catalyze esterifications, hydrolysis or transesterification processes, depending on the reaction conditions and substrates.

Since enzymatic reactions occur under mild temperatures and moderate pH ranges, as well as under ambient pressure, they generally require less energy and are conducted in equipment of lower capital cost than many other chemical processes.

Another advantage of lipase catalysis is related to their subtrate selectivities, which can be used in certain cases to achieve further purification levels. Reference is made to the numerous articles describing such processes; teaching the details of these processes, however, is not be the aim of this disclosure.

One feature of the lipase catalyzed transesterification process aimed at converting the purified EEs back into their nature-identical TG form in the presence of glycerol, is that the monoglyceride (MG) bond and diglyceride (DG) bonds are formed reasonably fast (minutes-to-hours).

But to further push the equilibrium to a predominantly tri-glyceride product form requires extended reaction times, sometimes with the addition of more catalyst, and the very effective removal of ethanol from the reaction mixture. For example, to push a reaction mixture that is composed of about 3-5% MG, 45% DG and 45% TG to the extent of >90% TG, the process can generally take more than double the reaction time.

This process significantly increases the cost of the reconstituted oil by extending equipment utilization, as well as the associated increased catalyst cycle time and hence, increasing catalyst cost significantly. Therefore, the more the equilibrium needs to be pushed towards completion of reconstitution of a substantially all TG product, the more expensive the reconstitution process from EEs to TGs becomes.

There is generally little commercial focus on the TG:DG ratio of reconstituted refined marine oil, as manufacturers tend to convert their oils mostly to a >80-90% TG form so that these reconstituted oils become as much “nature identical” as possible, despite the additional conversion cost. Therefore, most of the reconstituted highly refined triglyceride oils range anywhere from a 50:50 DG:TG up to >80-90% TG oil.

On the other hand, by controlling process variables, such as equivalent ratios of glycerol introduced, conversion time, etc., it is technically possible to get a purified 75-90% by weight DG out of most commercial reconstitution process.

MGs and DGs are common food additives and food emulsifiers that may be used to blend together certain ingredients, such as oil and water, which would not otherwise blend well. The commercial source may be either animal (cow- or hog-derived) or vegetable, derived primarily from partially hydrogenated soy bean and canola oil. They may also be synthetically produced.

MGs and DGs are used in a variety of applications to improve texture and emulsify water and fat mixtures. They are often found in bakery products, beverages, ice cream, peanut butter, chewing gum, shortening, whipped toppings, margarine, confections, and candies. MGs and DGs with higher levels of DGs are used mainly in shortenings, especially those made from oil. These shortenings are used for bakery products such as Danish, pies, puff pastries, cakes and cookies, as well as frying shortenings for donuts and pan fried applications.

Due to their generally low HLB of 3-8, MGs and DGs and their mixtures are slightly dispersing and are known to form milky water-in-oil emulsions, or are used in some cases for their wetting properties. Emulsions formed with MGs and DGs and their mixtures do not form stable emulsions. Their emulsification properties, therefore, differ greatly from the microemulsions formed with high HLB 13-18 emulsifiers, such as the ones described above. Triglycerides (TGs) on the other hand, do not display any dispersing properties at all, due to their zero or low (<2) HLB values.

Little-to-nothing is known about the dispersing properties of MGs/DGs derived via reconstitution of EEs after the purification process of marine oils. The MGs/DGs formed as intermediate products on the way to fully reconstituted commercial omega-3 EPA+DHA triglycerides have not been studied for their potential as food emulsifiers, due to their prohibitively high cost as compared to commercially available MGs and DGs derived from soy or canola oil, for example, and also due to their oxidative instability in foods which precludes most food applications of these products.

However, due to the slightly dispersing properties of omega-3 MGs and DGs derived from the purification/reconstitution refinement process of marine derived omega-3 EPA+DHA, these intermediates are not only excellent sources of omega-3 fatty acids, but in addition they display a remarkably improved formulation behavior over natural TGs or fully reconstituted TGs. That is, these MGs and DGs can be emulsified themselves by a high HLB emulsifier (of HLB>10), such as TPGS, PTS, PCS, PSS, Polysorbates (Tween 20-80), Peg-40 Hydrogenated Castor Oil, Peg-35 Castor Oil, Solutol HS-15, and certain High HLB sucrose esters, etc.

The formulation improvements of using omega-3 DGs or MGs over TGs are: 1) Significant lowering of the emulsifier to DG/MG ratios (from 3.0:1.0-3.5:1.0, or 2.5:1.0-3.5:1.0 or (for TGs) down to 1.5:1.0-1.0:1.0 (for DGs/MGs)); and 2) Significant reduction in the amount of water to generate a stable, clear microemulsion (from typically 60-70% or 55-70% (for TGs) down to 30-50% or 40-50% (for DGs/MGs) of the emulsion weight.

The significant reduction in emulsifier quantity needed, as well as the use of the much cheaper MGs/DGs omega-3 oil (as compared to the fully reconstituted omega-3 TGs), provide significant raw material cost savings for the same amount of omega-3 delivered in a DG/MG emulsion compared to a TG emulsion. Moreover, the per batch manufacturing cost for preparing such an emulsion is greatly reduced due to the much higher throughput, thanks to the much higher concentration of omega-3s in a DG/MG vs TG emulsion (reduced water content).

The reduction in emulsifier to DG/MG ratio also has as a very pleasant side effect in reduction of emulsifier taste (bitter, earthy, solvent taste), so that such emulsions need less flavor masking and flavor tweaking in finished product applications.

Overall, delivering omega-3 fatty acids in their DGs/MGs form in a high HLB surfactant-enabled, stabilized and clear microemulsion, provides significant cost savings of 30-50% as compared to the TG based emulsion ingredient, delivering the same amount of omega-3 EPA/DHA.

### EXPERIMENTAL

### Preparation of the Compositions:

The following examples illustrate the different compositions, using a variety of commercial TG oils and experimental DG oils, kindly provided by DSM, Incon Processing (Cyvex, a division of Omega-Protein), and GC Rieber Oils.

It has been also shown that the oxidative stabilization approach, based on U.S. Pat. No. 8,927,043, has been successfully applied to the DG/MG emulsion ingredients disclosed above. Representative formulations and examples include the following:

TABLE 1

| | | | | | Water | |
|---|---|---|---|---|---|---|
| | MG | DG | TG | Emulsifier | (balance of | |
| Formulations | (% wt/wt) | (% wt/wt) | (% wt/wt) | (surfactant) | formulation) | Additives |
| 1 | 5 | 10 | 75 | TPGS | — | None |
| 2 | 5 | 10 | 75 | PEG-40 | — | None |
| | | | | Hydrogenated | | |
| | | | | Castor Oil | | |
| 3 | 5 | 10 | 75 | Solutol HS-15 | — | None |
| 4 | 5 | 20 | 50 | TPGS | — | Vit. C |
| 5 | 5 | 20 | 50 | PEG-40 | — | Vit. C |
| | | | | Hydrogenated | | |
| | | | | Castor Oil | | |
| 6 | 5 | 20 | 50 | Solutol HS-15 | — | Vit. C |
| 7 | 10 | 20 | 25 | TPGS | — | None |
| 8 | 10 | 20 | 25 | PEG-40 | — | None |
| | | | | Hydrogenated | | |
| | | | | Castor Oil | | |
| 9 | 10 | 20 | 25 | Solutol HS-15 | — | None |
| 10 | 10 | 20 | 10 | TPGS | — | EDTA |
| 11 | 10 | 20 | 10 | PEG-40 | — | EDTA |
| | | | | Hydrogenated | | |
| | | | | Castor Oil | | |
| 12 | 10 | 20 | 10 | Solutol HS-15 | — | EDTA |
| 13 | 10 | 20 | 5 | TPGS | — | Vit. C |
| 14 | 10 | 20 | 5 | PEG-40 | — | Vit. C |
| | | | | Hydrogenated | | |
| | | | | Castor Oil | | |
| 15 | 10 | 20 | 5 | Solutol HS-15 | — | Vit. C |
| 16 | 15 | 20 | 3 | TPGS | — | EDTA |
| 17 | 15 | 20 | 3 | PEG-40 | — | EDTA |
| | | | | Hydrogenated | | |
| | | | | Castor Oil | | |
| 18 | 15 | 20 | 3 | Solutol HS-15 | — | EDTA |

It has been furthermore demonstrated that addition of the emulsions described in the experiments above, display all the advantageous emulsion properties in finished products, as previously described with emulsions based on TG oils.

Remarkably, the significant reduction in relative amounts of emulsifier to the DG/MG oils did not render the emulsion, nor a liquid finished product application fortified with that emulsion (such as an enhanced water at 40 mg of Omega-3 EPA+DHA per 240 mL serving, or a nutritional health shot at 250 mg of Omega-3 EPA+DHA per 2 ounce serving), unstable over time, in terms of clouding, precipitation, crystallization, oiling and/or ringing.

### Materials and Methods:

Oils and Chemicals: The following chemicals were used as stabilizers of the omega-3 fatty acids in the prepared emulsions.

Ascorbic Acid (Vitamin C) was bought from Parchem, New Rochelle, N.Y. Mixed tocopherols—Fortium MTD10—was bought from Kemin Industries, Des Moines, US. Calcium disodium EDTA—Versene CA—and TBHQ was purchased from The Dow Chemical Company, Midland, Mich., US. Guardian Chelox L was provided by Danisco, Elmsford, US.

GCRieber oils were provided by GCRIEBER, Kristiansand, Norway. Omega Protein oils were provided by Omega Protein, Houston, U.S. Life's DHA oil and MEG-3 60K were provided by DSM Nutritional Products, Inc., Parsippany, US. Kolliphor RH 40 and TPGS-Speziol(R) TPGS Pharma—were purchased from BASF Corporation, Florham Park, US.

TABLE 2
Omega-3 Oils used in experiments

| | | | Composition |
|---|---|---|---|
| | | | (Triglycerides [TG], |
| | Refer- | EPA + DHA | Diglycerides [DG], |
| Omega-3 Oil used | ence | [% w/w] | Monoglycerides [MG]) |
| High Omega-3 TG | | | |
| Oil Emulsions | | | |
| Rieber TG | T1 | 77 | 100% TG |
| (70DHAUltra-TG-4059) | | | |
| DSM life'sDHA | T2 | 36.2 | 100% TG |
| S35-O300 | | | |
| Omega Protein | T3 | 49.8 | 91.4% TG, 5.1% DG |
| 1946-100 TG | | | |
| DSM MEG-3 60K | T4 | 86 | >90% TG |
| High Omega-3 DG/MG | | | |
| Oil Emulsions | | | |
| Rieber 50:50 | D1 | 58 | 50% TG, 50% DG |
| Rieber DG | D2 | 48.5 | 10.9% TGs, 71.9% |
| | | | DG, 8.9% MG |
| Omega Protein | D3 | 51.2 | 20.6% TG, 79.0 DG |
| 13010 DG | | | |

### Preparation of Emulsions:

The components for each emulsion (according to Table 3 below) were weighed into a 250 mL Pyrex bottle (GC-8088, Chemglass, Vineland, US) under careful exclusion of oxygen, via an argon or nitrogen sweep. The bottle was then closed tightly and placed for 40-60 seconds on full power in a microwave oven (GE Profile, 1000W). The bottle was then taken out and opened carefully to release the built up pressure.

The bottle was put back in the microwave for another 20-30 seconds and then again opened and closed again for pressure release. This last step was repeated one more time. The bottle then rapidly cooled down, with vigorous pivoting movements, under running tap water, or in an ice bath, until the content reaches room temperature.

During the rapid cooling process the clear emulsions form. The bottle was carefully opened under an argon or nitrogen atmosphere, in order to fill the vacuum created in the bottle by the cooling process, and to avoid exposure to oxygen for subsequent experiments and long term storage for stability testing.

Every experiment was conducted with and without a suitable chosen mixture of antioxidants and chelators, in order to be able to compare the sensory performance over time of the emulsion systems studied, as a secondary outcome.

NB: In a lab setting, this procedure can be conducted in Pyrex bottles of varying sizes, but can also easily be scaled up to miniplant reactor setups using autoclaves, as well as production sized multi-purpose reactor setups, with connected efficient heating and cooling systems, the latter preferably being a discharge over a suitably dimensioned heat exchanger unit in a continuous fashion.

TABLE 3
Emulsion composition of conducted experiments

| | | | | | | | | | | |
|---|---|---|---|---|---|---|---|---|---|---|
| | | | | | | Calcium | | | | |
| | | | Kolliphor | | Omega-3 | disodium | Guardian | Ascorbic | Fortium | |
| Emulsion | Omega-3 | Water | RH40 | TPGS | Oil | EDTA | Chelox L | Acid | MTD10 | TBHQ |
| Experiment # | Oil Used | [g] | [g] | [g] | [g] | [g] | [g] | [g] | [g] | [g] |

High Omega-3 TG Oil Emulsions

| | | | | | | | | | | |
|---|---|---|---|---|---|---|---|---|---|---|
| 1 | T1 | 78.87 | 33.82 | | 13.50 | 1.58 | | 0.26 | 1.97 | |
| 2 | T1 | 43.75 | 19.69 | | 6.56 | | | | | |
| 3 | T1 | 66.85 | 33.43 | | 11.14 | 1.49 | | 0.25 | 1.85 | |
| 4 | T1 | 78.00 | 39.01 | | 12.99 | | | | | |
| 5 | T1 | 45.85 | 25.79 | | 8.59 | 1.15 | | 0.19 | 1.43 | |
| 6 | T1 | 56.00 | 31.51 | | 10.49 | | | | | |
| 7 | T1 | 50.00 | 32.78 | | 9.37 | 1.25 | | 0.21 | 1.56 | |
| 8 | T1 | 64.03 | 41.98 | | 12.00 | | | | | |
| 9 | T3 | 53.85 | 23.17 | | 9.27 | 1.12 | | 0.20 | 1.39 | |
| 10 | T3 | 58.04 | 24.97 | | 9.99 | | | | | |
| 11 | T1 | 56.35 | | 20.21 | 8.09 | 0.97 | | 0.16 | 1.21 | |
| 12 | T1 | 70.56 | | 25.31 | 10.13 | | | | | |
| 13 | T2 | 60.52 | 34.05 | | 11.34 | | 3.05 | 0.25 | 1.89 | |
| 14 | T2 | 47.43 | 26.68 | | 8.89 | | | | | |
| 15 | T2 | 52.54 | 29.55 | | 9.84 | 0.66 | | 0.22 | | 0.19 |
| 16 | T2 | 70.29 | 39.54 | | 13.17 | | | | | |
| 17 | T2 | 65.63 | 36.92 | | 10.42 | 0.83 | | 0.27 | 2.05 | |
| 18 | T2 | 64.00 | 36.01 | | 11.99 | | | | | |
| 19 | T4 | 56.64 | 25.60 | | 8.50 | 0.59 | | 0.19 | 1.46 | |
| 20 | T4 | 65.52 | 29.61 | | 9.87 | | | | | |

High Omega-3 DG/MG Oil Emulsions

| | | | | | | | | | | |
|---|---|---|---|---|---|---|---|---|---|---|
| 21 | D1 | 46.71 | 20.03 | | 8.00 | 0.93 | | 0.16 | 1.17 | |
| 22 | D1 | 79.38 | 34.04 | | 13.59 | | | | | |
| 23 | D1 | 84.33 | 35.08 | | 15.52 | 1.69 | | 0.28 | 2.10 | |
| 24 | D1 | 69.38 | 28.86 | | 12.77 | | | | | |
| 25 | D1 | 74.01 | 29.61 | | 14.80 | 1.48 | | 0.25 | 1.85 | |
| 26 | D1 | 61.69 | 24.68 | | 12.34 | | | | | |
| 27 | D1 | 58.01 | 29.00 | | 14.50 | 1.45 | | 0.24 | 1.81 | |
| 28 | D1 | 45.37 | 22.69 | | 11.34 | | | | | |
| 29 | D1 | 46.62 | 31.08 | | 15.54 | 1.55 | | 0.26 | 1.94 | |
| 30 | D1 | 56.50 | 37.67 | | 18.83 | | | | | |
| 31 | D1 | 83.72 | 30.14 | | 20.09 | 1.67 | | 0.28 | 2.09 | |
| 32 | D1 | 57.56 | 20.72 | | 13.82 | | | | | |
| 33 | D1 | 41.05 | 24.63 | | 16.42 | 1.37 | | 0.23 | 1.71 | |
| 34 | D1 | 41.15 | 24.69 | | 16.46 | | | | | |
| 35 | D1 | 48.46 | 40.38 | | 32.31 | 2.42 | | 0.41 | 3.02 | |
| 36 | D1 | 48.40 | 40.33 | | 32.27 | | | | | |
| 37 | D2 | 58.70 | 25.26 | | 10.11 | 1.21 | | 0.20 | 1.51 | |
| 38 | D2 | 70.52 | 30.34 | | 12.14 | | | | | |
| 39 | D2 | 79.89 | 32.09 | | 16.04 | 1.65 | | 0.28 | 2.06 | |
| 40 | D2 | 53.67 | 21.56 | | 10.77 | | | | | |
| 41 | D2 | 67.24 | 25.78 | | 14.72 | 1.39 | | 0.23 | 1.73 | |
| 42 | D2 | 50.55 | 19.38 | | 11.07 | | | | | |
| 43 | D2 | 77.47 | 28.00 | | 18.66 | 1.60 | | 0.27 | 2.00 | |
| 44 | D2 | 57.42 | 20.75 | | 13.83 | | | | | |
| 45 | D2 | 51.44 | 17.22 | | 13.77 | 1.06 | | 0.18 | 1.33 | |
| 46 | D2 | 73.64 | 24.65 | | 19.21 | | | | | |
| 47 | D2 | 58.70 | 17.68 | | 17.68 | 1.21 | | 0.20 | 1.51 | |
| 48 | D2 | 54.92 | 16.54 | | 16.54 | | | | | |
| 49 | D2 | 32.98 | 23.84 | | 15.89 | 1.36 | | 0.23 | 1.70 | |
| 50 | D2 | 48.54 | 35.08 | | 23.39 | | | | | |
| 51 | D2 | 55.10 | 36.89 | | 29.50 | 2.28 | | 0.38 | 2.84 | |
| 52 | D2 | 54.42 | 36.44 | | 29.14 | | | | | |
| 53 | D2 | 33.84 | 20.39 | | 20.39 | 1.40 | | 0.23 | 1.74 | |
| 54 | D2 | 48.98 | 29.51 | | 29.51 | | | | | |
| 55 | D3 | 59.91 | 25.78 | | 10.32 | 1.24 | | 0.21 | 1.54 | |
| 56 | D3 | 81.13 | 34.91 | | 13.97 | | | | | |
| 57 | D3 | 53.26 | 21.39 | | 10.69 | 1.10 | | 0.18 | 1.37 | |
| 58 | D3 | 66.15 | 26.57 | | 13.28 | | | | | |
| 59 | D3 | 55.68 | 21.35 | | 12.19 | 1.15 | | 0.19 | 1.44 | |
| 60 | D3 | 78.01 | 29.91 | | 17.08 | | | | | |
| 61 | D3 | 73.23 | 26.47 | | 17.64 | 1.51 | | 0.25 | 1.89 | |
| 62 | D3 | 49.30 | 17.82 | | 11.88 | | | | | |
| 63 | D3 | 37.23 | 22.43 | | 14.96 | 1.28 | | 0.22 | 1.60 | |
| 64 | D3 | 53.89 | 32.47 | | 21.64 | | | | | |
| 65 | D3 | 60.36 | 33.68 | | 26.93 | 2.08 | | 0.35 | 2.59 | |
| 66 | D3 | 47.90 | 26.73 | | 21.39 | | | | | |
| 67 | D3 | 37.97 | 25.42 | | 20.33 | 1.57 | | 0.26 | 1.96 | |
| 68 | D3 | 42.18 | 28.24 | | 22.58 | | | | | |
| 69 | D1 | 77.73 | | 27.88 | 11.16 | 1.34 | | 0.22 | 1.67 | |
| 70 | D1 | 75.22 | | 26.98 | 10.80 | | | | | |
| 71 | D1 | 66.72 | | 22.34 | 11.17 | 1.15 | | 0.19 | 1.43 | |
| 72 | D1 | 80.55 | | 26.97 | 13.48 | | | | | |
| 73 | D2 | 65.34 | 25.05 | | 14.3 | | 5.4 | 0.23 | 1.68 | |
| 74 | D2 | 69.9 | 26.8 | | 15.3 | | | | | |
| 75 | D2 | 54.61 | 20.93 | | 11.96 | 1.27 | | 0.19 | | 0.18 |
| 76 | D2 | 58.04 | 22.25 | | 12.71 | | | | | |

### Turbidity Measurements:

Turbidity of the emulsions was measured with a Oakton T-100 Turbidimeter form OAKTON Instruments, Vernon Hills, US, and readings recorded as Nephelometric Turbidity Units (NTUs). Three consecutive readings were recorded per measured sample and averaged.

### Sensory Evaluation:

Both undiluted emulsions and diluted emulsions were tested for taste and smell by a sensory panel composed of 4 team members. The diluted emulsion was prepared by adding 1 g of emulsion to 8 oz of a standardized flavored water product, and subjected to a taste test. Descriptive Analysis (DA) and Difference From Control (DFC) performed after 6 months and 18 months by the sensory panel, leading to a pass/fail decision.

### Results and Discussions

The aim of the experimental setup presented in Table 3 was primarily to investigate emulsion composition improvements with regard to emulsifier:oil ratios, and water content, when comparing emulsions prepared from high to 100% TG Omega-3 oils, as opposed to Oils lower in TG and higher in DG/MG composition, as described in Table 2.

The emulsions were characterized by measuring the resulting turbidity at the time of preparation, as well as by a long term observation of both the physicochemical (Table 4) and sensory (Table 5) stability of the emulsions over an 18 month observation period at room temperature, with an intermediary reading at 6 months from the time of preparation.

TABLE 4
Physicochemical emulsion properties and stability

| | | | | | | | |
|---|---|---|---|---|---|---|---|
| Emulsion | Omega-3 | Emulsifier | Emulsifier:Oil | Omega-3 | EPA + DHA | Water | Oxidative |
| Experiment # | Oil Used | Used | ratio | Oil % w/w | % w/w | % w/w | Stabilizers |

High Omega-3 TG Oil Emulsions

| | | | | | | | |
|---|---|---|---|---|---|---|---|
| 1 | T1 | Kolliphor RH 40 | 3 | 9.1 | 7.3 | 60.7 | A |
| 2 | T1 | Kolliphor RH 40 | 3 | 9.4 | 7.5 | 62.5 | — |
| 3 | T1 | Kolliphor RH 40 | 3 | 9.7 | 7.8 | 58.1 | A |
| 4 | T1 | Kolliphor RH 40 | 3 | 10.0 | 8.0 | 60.0 | — |
| 5 | T1 | Kolliphor RH 40 | 3 | 10.4 | 8.3 | 55.2 | A |
| 6 | T1 | Kolliphor RH 40 | 3 | 10.7 | 8.6 | 57.1 | — |
| 7 | T1 | Kolliphor RH 40 | 3.5 | 9.8 | 7.9 | 52.5 | A |
| 8 | T1 | Kolliphor RH 40 | 3.5 | 10.1 | 8.1 | 54.2 | — |
| 9 | T3 | Kolliphor RH 40 | 2.5 | 10.4 | 5.2 | 60.5 | A |
| 10 | T3 | Kolliphor RH 40 | 2.5 | 10.7 | 5.4 | 62.4 | — |
| 11 | T1 | TPGS | 2.5 | 9.3 | 5.1 | 64.8 | A |
| 12 | T1 | TPGS | 2.5 | 9.6 | 5.3 | 66.6 | — |
| 13 | T2 | Kolliphor RH 40 | 3 | 10.2 | 3.7 | 54.5 | B |
| 14 | T2 | Kolliphor RH 40 | 3 | 10.7 | 4.0 | 57.2 | — |
| 15 | T2 | Kolliphor RH 40 | 3 | 10.6 | 3.8 | 56.5 | C |
| 16 | T2 | Kolliphor RH 40 | 3 | 10.7 | 4.0 | 57.2 | — |
| 17 | T2 | Kolliphor RH 40 | 3 | 10.4 | 3.8 | 55.6 | A |
| 18 | T2 | Kolliphor RH 40 | 3 | 10.7 | 4.0 | 57.2 | — |
| 19 | T4 | Kolliphor RH 40 | 3 | 9.2 | 5.5 | 60.9 | A |
| 20 | T4 | Kolliphor RH 40 | 3 | 9.4 | 5.6 | 57.1 | — |

High Omega-3 DG/MG Oil Emulsions

| | | | | | | | |
|---|---|---|---|---|---|---|---|
| 21 | D1 | Kolliphor RH 40 | 2.5 | 10.4 | 5.7 | 60.7 | A |
| 22 | D1 | Kolliphor RH 40 | 2.5 | 10.7 | 5.9 | 62.5 | — |
| 23 | D1 | Kolliphor RH 40 | 2.25 | 11.2 | 6.2 | 60.7 | A |
| 24 | D1 | Kolliphor RH 40 | 2.25 | 11.5 | 6.4 | 62.5 | — |
| 25 | D1 | Kolliphor RH 40 | 2 | 12.1 | 6.7 | 60.7 | A |
| 26 | D1 | Kolliphor RH 40 | 2 | 12.3 | 6.9 | 62.5 | — |
| 27 | D1 | Kolliphor RH 40 | 2 | 13.8 | 7.6 | 55.2 | A |
| 28 | D1 | Kolliphor RH 40 | 2 | 14.3 | 7.9 | 57.1 | — |
| 29 | D1 | Kolliphor RH 40 | 2 | 16.0 | 8.9 | 48.1 | A |
| 30 | D1 | Kolliphor RH 40 | 2 | 16.7 | 9.2 | 50.0 | — |
| 31 | D1 | Kolliphor RH 40 | 1.5 | 14.6 | 8.0 | 60.7 | A |
| 32 | D1 | Kolliphor RH 40 | 1.5 | 15.0 | 8.3 | 62.5 | — |
| 33 | D1 | Kolliphor RH 40 | 1.5 | 19.2 | 10.6 | 48.1 | A |
| 34 | D1 | Kolliphor RH 40 | 1.5 | 20.0 | 11.1 | 50.0 | — |
| 35 | D1 | Kolliphor RH 40 | 1.25 | 25.4 | 14.1 | 38.2 | A |
| 36 | D1 | Kolliphor RH 40 | 1.25 | 26.7 | 14.7 | 40.0 | — |
| 37 | D2 | Kolliphor RH 40 | 2.5 | 10.4 | 4.7 | 60.5 | A |
| 38 | D2 | Kolliphor RH 40 | 2.5 | 10.7 | 4.9 | 62.4 | — |
| 39 | D2 | Kolliphor RH 40 | 2 | 12.2 | 5.5 | 60.5 | A |
| 40 | D2 | Kolliphor RH 40 | 2 | 12.5 | 5.7 | 62.4 | — |
| 41 | D2 | Kolliphor RH 40 | 1.75 | 13.3 | 6.0 | 60.5 | A |
| 42 | D2 | Kolliphor RH 40 | 1.75 | 13.7 | 6.2 | 62.4 | — |
| 43 | D2 | Kolliphor RH 40 | 1.5 | 14.6 | 6.6 | 60.5 | A |
| 44 | D2 | Kolliphor RH 40 | 1.5 | 15.0 | 6.8 | 62.4 | — |
| 45 | D2 | Kolliphor RH 40 | 1.25 | 16.2 | 7.4 | 60.5 | A |
| 46 | D2 | Kolliphor RH 40 | 1.25 | 16.7 | 7.6 | 62.4 | — |
| 47 | D2 | Kolliphor RH 40 | 1 | 18.2 | 8.3 | 60.5 | A |
| 48 | D2 | Kolliphor RH 40 | 1 | 18.8 | 8.5 | 62.4 | — |
| 49 | D2 | Kolliphor RH 40 | 1.5 | 20.9 | 9.5 | 43.4 | A |
| 50 | D2 | Kolliphor RH 40 | 1.5 | 21.9 | 9.9 | 45.4 | — |
| 51 | D2 | Kolliphor RH 40 | 1.25 | 23.2 | 10.6 | 43.4 | A |
| 52 | D2 | Kolliphor RH 40 | 1.25 | 24.3 | 11.0 | 45.4 | — |
| 53 | D2 | Kolliphor RH 40 | 1 | 26.1 | 11.9 | 43.4 | A |
| 54 | D2 | Kolliphor RH 40 | 1 | 27.3 | 12.4 | 45.4 | — |
| 55 | D3 | Kolliphor RH 40 | 2.5 | 10.4 | 5.8 | 60.5 | A |
| 56 | D3 | Kolliphor RH 40 | 2.5 | 10.7 | 5.9 | 62.4 | — |
| 57 | D3 | Kolliphor RH 40 | 2 | 10.7 | 6.7 | 60.5 | A |
| 58 | D3 | Kolliphor RH 40 | 2 | 12.5 | 6.9 | 62.4 | — |
| 59 | D3 | Kolliphor RH 40 | 1.75 | 13.3 | 7.3 | 60.5 | A |
| 60 | D3 | Kolliphor RH 40 | 1.75 | 13.7 | 7.5 | 62.4 | — |
| 61 | D3 | Kolliphor RH 40 | 1.5 | 14.6 | 8.0 | 60.5 | A |
| 62 | D3 | Kolliphor RH 40 | 1.5 | 15.0 | 8.3 | 62.4 | — |
| 63 | D3 | Kolliphor RH 40 | 1.5 | 19.2 | 10.6 | 47.9 | A |
| 64 | D3 | Kolliphor RH 40 | 1.5 | 20.0 | 11.1 | 49.9 | — |
| 65 | D3 | Kolliphor RH 40 | 1.25 | 21.4 | 11.8 | 47.9 | A |
| 66 | D3 | Kolliphor RH 40 | 1.25 | 22.3 | 12.3 | 49.9 | — |
| 67 | D3 | Kolliphor RH 40 | 1.25 | 23.2 | 12.8 | 43.4 | A |
| 68 | D3 | Kolliphor RH 40 | 1.25 | 24.3 | 13.4 | 45.4 | — |
| 69 | D1 | TPGS | 2.5 | 9.3 | 5.1 | 64.8 | A |
| 70 | D1 | TPGS | 2.5 | 9.6 | 5.3 | 66.6 | — |
| 71 | D1 | TPGS | 2 | 10.8 | 6.0 | 64.8 | A |
| 72 | D1 | TPGS | 2 | 11.1 | 6.2 | 66.6 | — |
| 73 | D2 | Kolliphor RH 40 | 1.75 | 12.8 | 5.8 | 58.3 | B |
| 74 | D2 | Kolliphor RH 40 | 1.75 | 13.7 | 6.2 | 62.4 | — |
| 75 | D2 | Kolliphor RH 40 | 1.75 | 13.4 | 6.1 | 54.6 | C |
| 76 | D2 | Kolliphor RH 40 | 1.75 | 13.7 | 6.2 | 62.4 | — |

| Emulsion | Turbidity | Turbidity | Turbidity | Stability | Stability | Stability |
|---|---|---|---|---|---|---|
| Experiment # | 0 months | 6 months | 18 months | 0 months | 6 months | 18 months |
| High Omega-3 TG Oil Emulsions | | | | | | |
| 1 | 198 | 203 | 245 | pass | pass | pass |
| 2 | 191 | 201 | 232 | pass | pass | pass |
| 3 | 198 | 187 | 209 | pass | pass | pass |
| 4 | 205 | 211 | 243 | pass | pass | pass |
| 5 | 173 | 147 | 163 | pass | pass | pass |
| 6 | 165 | 189 | 193 | pass | pass | pass |
| 7 | 137 | 128 | 153 | pass | pass | pass |
| 8 | 128 | 133 | 142 | pass | pass | pass |
| 9 | 110 | 142 | 257 | pass | pass | pass |
| 10 | 119 | 164 | 304 | pass | pass | pass |
| 11 | 143 | 245 | 882 | pass | pass | pass |
| 12 | 158 | 278 | 793 | pass | pass | pass |
| 13 | 71 | 79 | 94 | pass | pass | pass |
| 14 | 59 | 61 | 87 | pass | pass | pass |
| 15 | 63 | 68 | 72 | pass | pass | pass |
| 16 | 66 | 69 | 75 | pass | pass | pass |
| 17 | 67 | 73 | 72 | pass | pass | pass |
| 18 | 65 | 87 | 79 | pass | pass | pass |
| 19 | 74 | 88 | 92 | pass | pass | pass |
| 20 | 91 | 96 | 98 | pass | pass | pass |
| High Omega-3 DG/MG Oil Emulsions | | | | | | |
| 21 | 46 | 55 | 70 | pass | pass | pass |
| 22 | 43 | 48 | 41 | pass | pass | pass |
| 23 | 71 | 63 | 69 | pass | pass | pass |
| 24 | 67 | 88 | 100 | pass | pass | pass |
| 25 | 105 | 118 | 127 | pass | pass | pass |
| 26 | 99 | 104 | 119 | pass | pass | pass |
| 27 | 93 | 98 | 100 | pass | pass | pass |
| 28 | 87 | 107 | 117 | pass | pass | pass |
| 29 | 148 | 97 | 49 | pass | pass | pass |
| 30 | 133 | 149 | 173 | pass | pass | pass |
| 31 | 300 | 323 | 331 | pass | pass | pass |
| 32 | 278 | 299 | 372 | pass | pass | pass |
| 33 | 163 | 154 | 177 | pass | pass | pass |
| 34 | 154 | 34 | 76 | pass | pass | pass |
| 35 | 401 | 412 | 408 | pass | pass | pass |
| 36 | 387 | 411 | 413 | pass | pass | pass |
| 37 | 21 | 23 | 73 | pass | pass | pass |
| 38 | 25 | 29 | 33 | pass | pass | pass |
| 39 | 22 | 32 | 38 | pass | pass | pass |
| 40 | 37 | 43 | 89 | pass | pass | pass |
| 41 | 46 | 65 | 130 | pass | pass | pass |
| 42 | 53 | 78 | 139 | pass | pass | pass |
| 43 | 77 | 93 | 120 | pass | pass | pass |
| 44 | 83 | 98 | 149 | pass | pass | pass |
| 45 | 234 | 299 | 412 | pass | pass | pass |
| 46 | 218 | 275 | 421 | pass | pass | pass |
| 47 | 743 | 796 | 854 | pass | pass | pass |
| 48 | 734 | 817 | 888 | pass | pass | pass |
| 49 | 23 | 30 | >1000 | pass | pass | fail |
| 50 | 24 | 90 | >1000 | pass | pass | fail |
| 51 | 33 | 239 | >1000 | pass | pass | fail |
| 52 | 61 | 345 | >1000 | pass | pass | fail |
| 53 | 191 | 431 | 732 | pass | pass | pass |
| 54 | 204 | 418 | 754 | pass | pass | pass |
| 55 | 41 | 52 | 73 | pass | pass | pass |
| 56 | 38 | 44 | 87 | pass | pass | pass |
| 57 | 77 | 98 | 187 | pass | pass | pass |
| 58 | 63 | 196 | 213 | pass | pass | pass |
| 59 | 209 | 257 | 353 | pass | pass | pass |
| 60 | 201 | 298 | 398 | pass | pass | pass |
| 61 | 430 | 473 | 583 | pass | pass | pass |
| 62 | 309 | 523 | 638 | pass | pass | pass |
| 63 | 162 | 212 | 314 | pass | pass | pass |
| 64 | 176 | 259 | 346 | pass | pass | pass |
| 65 | 749 | 769 | 796 | pass | pass | pass |
| 66 | 711 | 810 | 853 | pass | pass | pass |
| 67 | 446 | 483 | 594 | pass | pass | pass |
| 68 | 413 | 503 | 611 | pass | pass | pass |
| 69 | 45 | 130 | n.a. | pass | pass | fail |
| 70 | 49 | 169 | n.a. | pass | pass | fail |
| 71 | 130 | 145 | 193 | pass | pass | pass |
| 72 | 139 | 187 | 217 | pass | pass | pass |
| 73 | 61 | 74 | 123 | pass | pass | pass |
| 74 | 59 | 64 | 138 | pass | pass | pass |
| 75 | 75 | 69 | 129 | pass | pass | pass |
| 76 | 65 | 77 | 197 | pass | pass | pass |

A: stabilizer mix of ascorbic acid, ca disodium EDTA, Fortium MTD10
B: stabilizer mix of ascorbic acid, Guardian Chelox L, Fortium MTD10
C: stabilizer mix of ascorbic acid, ca disodium EDTA, TBHQ

TABLE 5
Sensory emulsion stability

| | | | | | | |
|---|---|---|---|---|---|---|
| Emulsion | Omega-3 | Emulsifier | Oxidative | Sensory | Sensory | Sensory |
| Experiment # | Oil Used | Used | Stabilizers | 0 months | 6 months | 18 months |

High Omega-3 TG Oil Emulsions

| | | | | | | |
|---|---|---|---|---|---|---|
| 1 | T1 | Kolliphor RH 40 | A | pass | pass | pass |
| 2 | T1 | Kolliphor RH 40 | — | pass | fail | fail |
| 3 | T1 | Kolliphor RH 40 | A | pass | pass | pass |
| 4 | T1 | Kolliphor RH 40 | — | pass | fail | fail |
| 5 | T1 | Kolliphor RH 40 | A | pass | pass | pass |
| 6 | T1 | Kolliphor RH 40 | — | pass | fail | fail |
| 7 | T1 | Kolliphor RH 40 | A | pass | pass | pass |
| 8 | T1 | Kolliphor RH 40 | — | pass | fail | fail |
| 9 | T3 | Kolliphor RH 40 | A | pass | pass | pass |
| 10 | T3 | Kolliphor RH 40 | — | pass | fail | fail |
| 11 | T1 | TPGS | A | pass | pass | pass |
| 12 | T1 | TPGS | — | pass | fail | fail |
| 13 | T2 | Kolliphor RH 40 | B | pass | pass | pass |
| 14 | T2 | Kolliphor RH 40 | — | pass | fail | fail |
| 15 | T2 | Kolliphor RH 40 | C | pass | pass | pass |
| 16 | T2 | Kolliphor RH 40 | — | pass | fail | fail |
| 17 | T2 | Kolliphor RH 40 | A | pass | pass | pass |
| 18 | T2 | Kolliphor RH 40 | — | pass | fail | fail |
| 19 | T4 | Kolliphor RH 40 | A | pass | pass | pass |
| 20 | T4 | Kolliphor RH 40 | — | pass | fail | fail |

High Omega-3 DG/MG Oil Emulsions

| | | | | | | |
|---|---|---|---|---|---|---|
| 21 | D1 | Kolliphor RH 40 | A | pass | pass | pass |
| 22 | D1 | Kolliphor RH 40 | — | pass | fail | fail |
| 23 | D1 | Kolliphor RH 40 | A | pass | pass | pass |
| 24 | D1 | Kolliphor RH 40 | — | pass | fail | fail |
| 25 | D1 | Kolliphor RH 40 | A | pass | pass | pass |
| 26 | D1 | Kolliphor RH 40 | — | pass | pass | fail |
| 27 | D1 | Kolliphor RH 40 | A | pass | pass | pass |
| 28 | D1 | Kolliphor RH 40 | — | pass | fail | fail |
| 29 | D1 | Kolliphor RH 40 | A | pass | pass | pass |
| 30 | D1 | Kolliphor RH 40 | — | pass | pass | fail |
| 31 | D1 | Kolliphor RH 40 | A | pass | pass | pass |
| 32 | D1 | Kolliphor RH 40 | — | pass | fail | fail |
| 33 | D1 | Kolliphor RH 40 | A | pass | pass | pass |
| 34 | D1 | Kolliphor RH 40 | — | pass | pass | fail |
| 35 | D1 | Kolliphor RH 40 | A | pass | pass | pass |
| 36 | D1 | Kolliphor RH 40 | — | pass | fail | fail |
| 37 | D2 | Kolliphor RH 40 | A | pass | pass | pass |
| 38 | D2 | Kolliphor RH 40 | — | pass | fail | fail |
| 39 | D2 | Kolliphor RH 40 | A | pass | pass | pass |
| 40 | D2 | Kolliphor RH 40 | — | pass | fail | fail |
| 41 | D2 | Kolliphor RH 40 | A | pass | pass | pass |
| 42 | D2 | Kolliphor RH 40 | — | pass | fail | fail |
| 43 | D2 | Kolliphor RH 40 | A | pass | pass | pass |
| 44 | D2 | Kolliphor RH 40 | — | pass | fail | fail |
| 45 | D2 | Kolliphor RH 40 | A | pass | pass | pass |
| 46 | D2 | Kolliphor RH 40 | — | pass | fail | fail |
| 47 | D2 | Kolliphor RH 40 | A | pass | pass | pass |
| 48 | D2 | Kolliphor RH 40 | — | pass | fail | fail |
| 49 | D2 | Kolliphor RH 40 | A | pass | pass | pass |
| 50 | D2 | Kolliphor RH 40 | — | pass | fail | fail |
| 51 | D2 | Kolliphor RH 40 | A | pass | pass | pass |
| 52 | D2 | Kolliphor RH 40 | — | pass | fail | fail |
| 53 | D2 | Kolliphor RH 40 | A | pass | pass | pass |
| 54 | D2 | Kolliphor RH 40 | — | pass | fail | fail |
| 55 | D3 | Kolliphor RH 40 | A | pass | pass | pass |
| 56 | D3 | Kolliphor RH 40 | — | pass | fail | fail |
| 57 | D3 | Kolliphor RH 40 | A | pass | pass | pass |
| 58 | D3 | Kolliphor RH 40 | — | pass | fail | fail |
| 59 | D3 | Kolliphor RH 40 | A | pass | pass | pass |
| 60 | D3 | Kolliphor RH 40 | — | pass | fail | fail |
| 61 | D3 | Kolliphor RH 40 | A | pass | pass | pass |
| 62 | D3 | Kolliphor RH 40 | — | pass | fail | fail |
| 63 | D3 | Kolliphor RH 40 | A | pass | pass | pass |
| 64 | D3 | Kolliphor RH 40 | — | pass | fail | fail |
| 65 | D3 | Kolliphor RH 40 | A | pass | pass | pass |
| 66 | D3 | Kolliphor RH 40 | — | pass | fail | fail |
| 67 | D3 | Kolliphor RH 40 | A | pass | pass | pass |
| 68 | D3 | Kolliphor RH 40 | — | pass | fail | fail |
| 69 | D1 | TPGS | A | pass | pass | pass |
| 70 | D1 | TPGS | — | pass | fail | fail |
| 71 | D1 | TPGS | A | pass | pass | pass |
| 72 | D1 | TPGS | — | pass | fail | fail |
| 73 | D2 | Kolliphor RH 41 | B | pass | pass | pass |
| 74 | D2 | Kolliphor RH 41 | — | pass | fail | fail |
| 75 | D2 | Kolliphor RH 41 | C | pass | pass | pass |
| 76 | D2 | Kolliphor RH 41 | — | pass | fail | fail |

A: stabilizer mix of ascorbic acid, ca disodium EDTA, Fortium MTD10
B: stabilizer mix of ascorbic acid, Guardian Chelox L, Fortium MTD10
C: stabilizer mix of ascorbic acid, ca disodium EDTA, TBHQ

High TG Oils require at least a 2.5 to 3.5 emulsifier to omega-3 oil ratio, in order to yield pysicochemically stable emulsions with an turbidity level. See experiments 1-20. When attempting to create formulations with any of the 4 high TG oils at emulsifier to oil ratios BELOW 2.5, it is not possible to create homogeneous or clear emulsion with turbidity reading below 1000. These failed emulsion preparation attempts have not been included in Table 4 above. Also, the water percentage in the high TG experiments could not be lessened to below 50%, and ranged typically between 50% and 70%. Consequently, the percentage of omega-3 oil able to be incorporated as TGs into the emulsion never exceeded 11% w/w, and maxed out in a rather constant percentage range of 9.1 to 10.7%. Given the EPA/DHA content within these oils, the maximum level of EPA/DHA concentration delivered, never exceeded 8.6%, and typically ranged between 3.7% and 8.6%.

However, when using omega-3 oils with a lower TG and consequently higher DG/MG content, we found that for a long term physicochemically stable emulsion with acceptable turbidities substantially lower than 1000 NTUs, we could surprisingly significantly lower the emulsifier to oil ratio down to 1.25:1.0 (Experiments #35-36, #45-46, #65-68) or even 1.0:1.0 (Experiments #47-48, #53-54), while favorably being able to decrease water content alongside, to typical lowest values ranging between 38.2% (Experiment #35) to 43.4% (Experiment #67) or 47.9% (Experiment #63). As a result of the ratio improvement and water content lowering, we were able to incorporate up to 26.7% of high DG/MG omega-3 (Experiment #36), which presents a 2.5 fold improvement in oil load achieved through the optimized emulsion over high TG omega-3 oils emulsions. This omega-3 oil load improvement consequently resulted in a significant improvement in the EPA/DHA content of the DG/MG Oil emulsions of up to 14.7% w/w EPA/DHA (Experiment #36).

When looking at the physicochemical stability of the high DG/MG emulsion of the 18 month observation period, only very few failed the 18 month Turbidity cut off point of 1000 NTU and physicochemical stability. The predominant observation for experiments #21 through #76 was the total absence of phase separation phenomena such as coalescence, creaming, sedimentation, or Ostwald ripening.

We also studied the long term sensory stability of all emulsions by side by side comparison experiments, using suitable chosen cocktails of antioxidants and chelator. We observed that in almost all cases, the DG/MG emulsions stabilized in a similar fashion than known to be effective for TG emulsions, essentially produced the same long term sensory stability for the DG/MG emulsions. As expected, all but three non-stabilized emulsions, failed our standardized sensory test already after the 6 month mark, with a all non-stabilized emulsions failing the 18 month mark.

The emulsions prepared may be used in the fortification of water compositions and shots. In another embodiment, the emulsions may be used to prepare gelatin formulations, dropper formulations and related applications and formulations.

### SUMMARY OF THE INVENTION

The following embodiments, aspects and variations thereof are exemplary and illustrative are not intended to be limiting in scope.

In one aspect, there is provided a composition comprising a stable, aqueous omega-3 fatty acid composition comprising:

a) water;

b) a high HLB non-ionic emulsifier with HLB>10; and

c) a marine oil, an algae derived oil or a vegetable oil high in omega-3 fatty acid comprising a total glycerides comprising a monoglyceride (MG), a diglyceride (DG) and a triglyceride (TG) of the omega-3 fatty acid, wherein the TG of the omega-3 fatty acid content in the composition is less than 80% of the total glycerides.

In one variation, the TG content is less than 75%, less than 70%, less than 65%, less than 60%, less than 55%, less than 50%, less than 40%, less than 40%, less than 30%, less than 20% or less than 10% in the composition.

In one aspect of the above composition, the high HLB emulsifier is selected from the group consisting of TPGS, PTS, Polysorbates, PEG-40 Hydrogenated Castor Oil (Cremophor/Kolliphor RH 40), PEG-35 castor oil (Cremophor EL), Solutol HS-15 and sucrose esters, or mixtures thereof. In one variation, the Polysorbates include all different tweens, Polysorbate 20 (Polyoxyethylene (20) sorbitan monolaurate), Polysorbate 40 (Polyoxyethylene (20) sorbitan monopalmitate), Polysorbate 60 (Polyoxyethylene (20) sorbitan monostearate), and Polysorbate 80 (Polyoxyethylene (20) sorbitan monooleate).

In another aspect of the composition, the marine oil has a DG content of 10-90% of the total glycerides. In one variation, the marine oil has a DG content of 15%, 20%, 25%, 30%, 35%, 40%, 50%, 60%, 70%, 80% or 90%. In another variation, the marine oil has a DG content in the range of about 10% to 15%, 10% to 20%, 15% to 20%, 15% to 25%, 20% to 25%, 15% to 35%, 25% to 30%, 25% to 35%, 30% to 35%, 30% to 40%, 40% to 50%, 50% to 60%, 60% to 70%, 70% to 80% and 80% to 90%.

In another aspect of the composition, the marine oil has MG content of 10-90% of the total glycerides. In one variation, the marine oil has a MG content of 15%, 20%, 25%, 30%, 35%, 40%, 50%, 60%, 70%, 80% or 90%. In another variation, the marine oil has a DG content in the range of about 10% to 15%, 10% to 20%, 15% to 20%, 15% to 25%, 20% to 25%, 15% to 35%, 25% to 30%, 25% to 35%, 30% to 35%, 30% to 40%, 40% to 50%, 50% to 60%, 60% to 70%, 70% to 80% and 80% to 90%.

In another aspect of the composition, the total marine oil content is 30% wt/wt or less of the mixture comprising the MG, the DG and the TG of the omega-3 fatty acid. In one variation, the total marine oil content is 25% or less, 20% or less, 15% or less or 10% or less of the mixture comprising the MG, the DG and the TG of the omega-3 fatty acid.

In another aspect of the above composition, the omega-3 fatty acid content in the composition comprising the MG, the DG and the TG of the omega-3 fatty acid is 5-20% wt/wt. In one variation, the omega-3 fatty acid content in the composition is about 5% wt/wt, 10% wt/wt, 15% wt/wt or 20% wt/wt of the composition.

In another aspect of the above composition, the water content is between 30 and 70%, or between 40 and 70% wt/wt of total mixture. In one variation, the water content is about 35% wt/wt, 40% wt/wt, 45% wt/wt, 50% wt/wt, 55% wt/wt, 60% wt/wt, 65% wt/wt or 70% wt/wt.

In another aspect of the composition, the composition further comprises at least one additives selected from the group consisting of a water soluble reducing agent, a hydrophilic reducing agent, a radical scavenger, a lipophilic reducing agent, and a metal chelator, or a mixture thereof. In one variation, the composition comprises at least two additives selected from the group consisting of a hydrophilic reducing agent, a radical scavenger, a lipophilic reducing agent and a metal chelator. In another aspect of the composition, the water soluble reducing agent is selected from the group comprised of Vitamin C (Ascorbic Acid) and a Vitamin C salt. In one variation, the Vitamin C salt is sodium ascorbate.

In another aspect of the composition, the lipophilic reducing agent is selected from a group consisting of ascorbyl palmitate, Vitamin E and Vitamin E derivatives (alpha, beta, gamma and delta-tocopherols, and their mixtures (natural mixed tocopherols)), tocotrienols, ubiquinol, quercitin, cyanidin, catechin, 6,7-dihydroxyflavone, 7,8-dihydroxyflavone, 7,8-dihydroxycumarin, carotinoids such as beta-carotene, phenols and polyphenols (e.g. Lignin), vanillin, BHA (tert-butyl-4-hydroxyanisole), BHT (2,6-di-tert-butyl-p-hydroxytoluene, propyl-, octyl- and dodecylgallate, TBHQ (tert-butyl-hydroquinone) and ethoxyquin (6-ethoxy-12-dihydro-2,2,4-trimethylquinoline). In one aspect of the composition, the metal chelator is selected from the group consisting of EDTA, disodium EDTA, calcium disodium EDTA, pyrophosphates, (e.g. tetra-potassium pyrophosphate), Guardian Chelox L, citric acid and citric acid salts, or mixtures thereof.

In another aspect of the composition, the metal chelator is calcium disodium EDTA, the hydrophilic reducing agent/radical scavenger is Vitamin C, and the lipophilic reducing agent/radical scavenger is a natural mixed tocopherol blend with high gamma, and delta tocopherol content.

In another embodiment, there is provided a method for the preparation of a stable, aqueous omega-3 fatty acid composition comprising:

a) water;

b) a high HLB non-ionic emulsifier with HLB>10; and

c) a marine oil, an algae derived oil or a vegetable oil high in omega-3 fatty acid comprising a total glycerides comprising a monoglyceride (MG), a diglyceride (DG) and a triglyceride (TG) of the omega-3 fatty acid,

wherein the TG of the omega-3 fatty acid content in the composition is less than 80% of the total glycerides; the method comprising:

1) combining a mixture of omega-3 MGs, DGs and TGs comprising at least 20% of MGs and DGs derived from a purification or reconstitution refinement process of marine derived omega-3 with the high HLB non-ionic emulsifier to form a mixture; and 2) adding the non-ionic emulsifier to the mixture to form the stable composition. In one variation, the TG content is less than 75%, less than 70%, less than 65%, less than 60%, less than 55%, less than 50%, less than 40%, less than 40%, less than 30%, less than 20% or less than 10% in the composition.

In another aspect of the above method, the TG of the omega-3 fatty acid content in the composition is less than 50%, 40%, 30% or 20% of the total glycerides. In one variation, the marine oil has a DG content of 15%, 20%, 25%, 30%, 35%, 40%, 50%, 60%, 70%, 80% or 90%. In another variation, the marine oil has a DG content in the range of about 10% to 15%, 10% to 20%, 15% to 20%, 15% to 25%, 20% to 25%, 15% to 35%, 25% to 30%, 25% to 35%, 30% to 35%, 30% to 40%, 40% to 50%, 50% to 60%, 60% to 70%, 70% to 80% and 80% to 90%. In another variation of the method, the marine oil has a MG content of 15%, 20%, 25%, 30%, 35%, 40%, 50%, 60%, 70%, 80% or 90%. In another variation, the marine oil has a DG content in the range of about 10% to 15%, 10% to 20%, 15% to 20%, 15% to 25%, 20% to 25%, 15% to 35%, 25% to 30%, 25% to 35%, 30% to 35%, 30% to 40%, 40% to 50%, 50% to 60%, 60% to 70%, 70% to 80% and 80% to 90%. In another variation of the method, the total marine oil content is 25% or less, 20% or less, 15% or less or 10% or less of the mixture comprising the MG, the DG and the TG of the omega-3 fatty acid. In another aspect of the method, the water content is between 30 and 70% wt/wt of total mixture. In one variation, the water content is about 35% wt/wt, 40% wt/wt, 45% wt/wt, 50% wt/wt, 55% wt/wt, 60% wt/wt, 65% wt/wt or 70% wt/wt.

In another aspect of the above method, the method further comprising the addition of at least one additives selected from the group consisting of a water soluble reducing agent, a hydrophilic reducing agent, a radical scavenger, a lipophilic reducing agent, and a metal chelator, or a mixture thereof. In one variation, the composition comprises at least two additives selected from the group consisting of a hydrophilic reducing agent, a radical scavenger, a lipophilic reducing agent and a metal chelator. In another aspect of the above method, the omega-3 is omega-3 comprising EPA and DHA. In another aspect, the omega-3 fatty acid is a marine oil derived omega-3 fatty acid.

The foregoing examples of the related art and limitations are intended to be illustrative and not exclusive. Other limitations of the related art will become apparent to those of skill in the art upon a reading of the specification and a study of the drawings or figures as provided herein.

In addition to the exemplary embodiments, aspects and variations described above, further embodiments, aspects and variations will become apparent by reference to the drawings and figures and by examination of the following descriptions.

### DETAILED DESCRIPTION OF THE INVENTION

### Definitions

Unless specifically noted otherwise herein, the definitions of the terms used are standard definitions used in the art of organic synthesis and pharmaceutical sciences. Exemplary embodiments, aspects and variations are illustrative in the figures and drawings, and it is intended that the embodiments, aspects and variations, and the figures and drawings disclosed herein are to be considered illustrative and not limiting.

The term “aqueous composition”, “aqueous formulation” or “aqueous emulsion” refers to a composition or formulation of the present application including at least about 5% (w/w) water. In one example, an aqueous formulation includes at least about 10%, at least about 20%, at least about 30% at least about 40% or at least about 50% (w/w) of water; or as disclosed herein.

The term “emulsion” refers to a lipophilic molecule of the present application emulsified (solubilized) in an aqueous medium using a solubilizing agent. In one example, the emulsion includes micelles formed between the lipophilic molecule(s) and the solubilizing agent. When those micelles are sufficiently small, the emulsion is essentially clear. Typically, the emulsion will appear clear (e.g., transparent) to the normal human eye, when those micelles have a median particle size of less than 100 nm. In one example, the micelles in the emulsions of the present application have median particle sizes below 60 nm. In a typical example, micelles formed in an emulsion of the present application have a median particle size between about 20 and about 30 nm. In another example, the emulsion is stable, which means that separation between the aqueous phase and the lipophilic component does essentially not occur (e.g., the emulsion stays clear). A typical aqueous medium, which is used in the emulsions of the present application, is water, which may optionally contain other solubilized molecules, such as salts, coloring agents, flavoring agents and the like. In one example, the aqueous medium of the emulsion does not include an alcoholic solvent, such as ethanol or methanol.

Another measure of particle size, which is more suitable for the production environment and commercial quality testing is a turbidity measurement (expressed for example in Nephelometric Turbidity Units (NTU)) of the emulsion ingredient itself as well as the fortified finished product. In one example, the emulsion is essentially clear, which is usually the case when turbidity measurements are below 1000 NTU. In another examples emulsions have NTU values of less than 800 NTU, less than 600 NTU, less than 400 NTU, less than 200 NTU, or less than 100 NTU. Typically, the emulsion will appear clear (e.g., transparent) to the normal human eye, when NTU values are below 200 NTU, but values up to 1000 NTU will also yield essentially clear beverages and other finished liquid products, when the emulsions are used for their fortification.

The term “essentially stable to chemical degradation” refers to the MG, DG and TG (molecules or compounds) of the present application as contained in a formulation (e.g., aqueous formulation), beverage or other composition. In one example, “essentially stable to chemical degradation” means that the molecule or compound is stable in its original (e.g., reduced) form and is not converted to another species (e.g., oxidized species; any other species including more or less atoms; any other species having an essentially different molecular structure), for example, through oxidation, cleavage, rearrangement, polymerization and the like, including those processes induced by light (e.g., radical mechanisms). Examples of chemical degradation include oxidation and/or cleavage of double bonds in unsaturated fatty acids and light-induced rearrangements of unsaturated molecules. Certain degradation products of omega-3-fatty acids include aldehydes. The molecule is considered to be essentially stable when the concentration of its original (e.g., reduced) form in the composition (e.g., aqueous formulation) is not significantly diminished over time. For example, the molecule is essentially stable when the concentration of the original form of the molecule remains at least 80% when compared with the concentration of the original form of the molecule at about the time when the composition was prepared. In another example, the molecule is essentially stable when the concentration of the original form remains at least about 85%, at least about 90% or at least about 95% of the original concentration.

The term “essentially clear” is used herein to describe the compositions (e.g., formulations) of the present application. For example, the term “essentially clear” is used to describe an aqueous formulation or a beverage of the present application. In one example, clarity is assessed by the normal human eye. In this example, “essentially clear” means that the composition is transparent and essentially free of visible particles and/or precipitation (e.g., not visibly cloudy, hazy or otherwise non-homogeneous). In another example, clarity, haziness or cloudiness of a composition is assessed using light scattering technology, such as dynamic light scattering (DLS), which is useful to measure the sizes of particles, e.g., micelles, contained in a composition. In one example, “essentially clear” means that the median particle size as measured by DLS is less than about 100 nm. For example, when the median particle size is less than 100 nm the liquid appears clear to the human eye. In another example, “essentially clear” means that the median particle size is less than about 80 nm. In yet another example, “essentially clear” means that the median particle size is less than about 60 nm. In a further example, “essentially clear” means that the median particle size is less than about 40 nm. In another example, “essentially clear” means that the median particle size is between about 20 and about 30 nm.

“HLB” refers to the hydrophilic-lipophilic balance of a surfactant or an is a measure of the degree to which it is hydrophilic or lipophilic that may be determined by calculating values for the different regions of the molecule as known in the art. HLB may also be defined as an empirical expression for the relationship of the hydrophilic (“water-loving”) and hydrophobic (“water-hating”) groups of a surfactant.

The term “metal chelator” or “metal chelating moiety” as used herein refers to a compound that may combine with a metal ion, such as iron, to form a chelate structure. The chelating agents form coordinate covalent bonds with a metal ion to form the chelates. Accordingly, chelates are coordination compounds in which a central metal atom is bonded to two or more other atoms in at least one other molecule (ligand) such that at least one heterocyclic ring is formed with the metal atom as part of each ring. As used herein, the metal chelator has demonstrated affinity for iron. These ions may be free in solution or they may be sequestered by a metal ion-binding moiety. The term “metal ion” as used herein refers to any physiological, environmental and/or nutritionally relevant metal ion. Such metal ions include certain metal ions such as iron, but may also include lead, mercury and nickel. When EDTA (or disodium EDTA or calcium disodium EDTA) is used in the present application to chelate iron, the chelate forms a Fe³⁺ ethylene-diaminetetraacetic acid (EDTA) complex. Effective chelating properties for the purpose of the present emulsion system can also be derived using Guardian Chelox L, as well as citric acid and its salts, as disclosed herein.

The term “omega-fatty acid(s)” or “omega-3-fatty acid(s)” are used interchangeably to mean the same composition, as known in the art, and include, for example, omega-3-, omega-6- and omega-9-fatty acids. Such omega-fatty acids are the naturally occurring plant derived oils (including algae derived oils) or fish oils that are the mono-, di- and triglyceride derivatives of omega-fatty acids. Non-naturally occurring (or non-natural) omega-fatty acids or omega-3-fatty acids include the non-glyceride esters of the omega-3-fatty acids. Such non-naturally occurring omega-fatty acids include the ethyl esters of omega-fatty acids that are, for example, the omega-3-, omega-6- and omega-9-fatty acids ethyl esters, and are also referred to as fatty acids ethyl esters (FAEE) or EEs fish oil. In certain embodiments of the present application, the non-naturally occurring omega-fatty acids used in the compositions of the present application comprise the C₁₋₁₀ alkyl esters, the C₁₋₅ alkyl esters, the C₁₋₃ alkyl esters or the C₂₋₅ alkyl esters. In certain embodiments, the C₁₋₁₀ alkyl ester include the methyl ester or the ethyl ester of the omega-3 fatty acid. Further, in certain embodiments of the present application, the omega-fatty acids used in the composition of the present application are a mixture of the triglycerides of the omega-fatty acids and (i.e., mixed with) the omega-fatty acid esters, as defined herein. Accordingly, as used herein, unless otherwise noted, the term “omega-fatty acids” as used in each aspects, variations and embodiments of the formulations of the present application include the natural omega-fatty acids, the non-natural omega-fatty acids, and their esters, and mixtures thereof, as defined herein.

“Marine oil” refers to a fish or marine oil, such as salmon oil, cod liver oil, sardine oil, anchovy oil, haik oil, polack oil, manhadon oil or hill oil, or mixtures of the oil.

“Omega fatty acid(s)” refers to an omega-3 fatty acids, an oil comprising at least one type of an omega-6 fatty acid, an oil comprising at least one type of an omega-9 fatty acid and an oil comprising at least one type of an omega-12 fatty acid. Exemplary types of omega-3 fatty acid, omega-6 fatty acid, omega-9 fatty acid and omega-12 fatty acid are disclosed herein. The omega-3 unsaturated fatty acid may include alpha-linolenic acid (ALA), docosahexaenoic acid (DHA), eicosapentaenoic acid (EPA), stearidonic acid, eicosatetraenoic acid and docosapentaenoic acid. In another aspect, the omega fatty acid is an omega-6 unsaturated fatty acid, such as linoleic acid, gamma-linolenic acid and arachidonic acid. In yet another aspect, the omega-9 unsaturated fatty acid is an oleic acid, eicosenoic acid and erucic acid, as well as conjugated linoleic acid (CLA). In one aspect, the omega fatty acid is an omega-12 unsaturated fatty acid. The term “fatty acid” also includes any derivative of those compounds, such as mixed monoglyceride (MG), diglyceride (DG) and triglyceride (TG) esters, such as methyl- and ethyl esters; or mixtures thereof.

The term “reducing agent” is any compound capable of reducing another compound of the present application to its reduced form. “Reducing agent” includes lipophilic (e.g., lipid-soluble) reducing agents. In one example, the lipid-soluble reducing agent incorporates a hydrophobic moiety, such as a substituted or unsubstituted carbon chain (e.g., a carbon chain consisting of at least 10 carbon atoms). “Reducing agent” also includes hydrophilic (e.g., water-soluble) reducing agents. In one variation, the reducing agent that may be employed in the formulation is ubiquinol.

The terms “stabilizer”, and “antioxidant”, are recognized in the art and refer to synthetic or natural substances that prevent or delay the oxidative or free radical or photo induced deterioration of a compound, and combinations thereof. Exemplary stabilizers include tocopherols, flavonoids, catechins, superoxide dismutase, lecithin, gamma oryzanol; vitamins, such as vitamins A, C (ascorbic acid) and E (tocopherol and tocopherol homologues and isomers, especially alpha and gamma- and delta-tocopherol) and beta-carotene (or related carrotenoids); natural components such as camosol, carnosic acid and rosmanol found in rosemary and hawthorn extract, proanthocyanidins such as those found in grape seed or pine bark extract, and green tea extract. In one variation, the vitamin E includes all 8-isomers (all-rac-alpha-tocopherol), and also include d,l-tocopherol or d,l-tocopherol acetate. In one variation, the vitamin E is the d,d,d-alpha form of vitamin E (also known as natural 2R,4R′,8R′-alpha-tocopherol). In another variation, the vitamin E includes natural, synthetic and semi-synthetic compositions and combinations thereof.

In one example, the reducing agent is a “water-soluble reducing agent” when the reducing agent dissolves in water (e.g., at ambient temperature) to produce a clear solution, as opposed to a visibly cloudy, hazy or otherwise inhomogeneous mixture, or even a two phase system. In one example, the reducing agent is a “water-soluble reducing agent” when it includes at least one (e.g., at least two) hydroxyl group(s) and does not include a large hydrophobic moiety (e.g., a substituted or unsubstituted linear carbon chain consisting of more than 10, 11, 12, 13, 14, 15, 16, 17, 18, 19 or 20 carbon atoms). In another example, the reducing agent is a “water-soluble reducing agent” when it includes at least one (e.g., at least two) hydroxyl group(s) and includes a substituted or unsubstituted linear carbon chain consisting of not more 6, 8, 10, 11, 12, 13, 14 or 15 carbon atoms. An exemplary water-soluble reducing agent is ascorbic acid. The term “water-soluble reducing agent” also includes mixtures of vitamin C with a omega-3 ester of the present application. Water-soluble reducing agents can be derivatized to afford an essentially lipid-soluble reducing agent (pro-reducing agent). For example, the water-soluble reducing agent is derivatized with a fatty acid to give, e.g., a fatty acid ester. An exemplary lipid-soluble reducing agent is ascorbic acid-palmitate.

“Total glycerides” or “glyceride content” of a composition refers to a combined mixture containing a monoglyceride (MG), diglyceride (DG) and triglyceride (TG) of an omega-3 fatty acid.

The term “water-soluble” when referring to a formulation or compositions of the present application, means that the formulation when added to an aqueous medium (e.g., water, original beverage) dissolves in the aqueous medium to produce a solution that is essentially clear. In one example, the formulation dissolves in the aqueous medium without heating the resulting mixture above ambient temperature (e.g., 25° C.). The term “essentially clear” is defined herein.

While a number of exemplary embodiments, aspects and variations have been provided herein, those of skill in the art will recognize certain modifications, permutations, additions and combinations and certain sub-combinations of the embodiments, aspects and variations. It is intended that the following claims are interpreted to include all such modifications, permutations, additions and combinations and certain sub-combinations of the embodiments, aspects and variations are within their scope.

The entire disclosures of all documents cited throughout this application are incorporated herein by reference.

What is claimed is:

1. A stable, aqueous omega-3 fatty acid composition comprising:
a) water;
b) a high HLB non-ionic emulsifier with HLB>10; and
c) a marine oil, an algae derived oil or a vegetable oil high in omega-3 fatty acid comprising a total glycerides comprising a monoglyceride (MG), a diglyceride (DG) and a triglyceride (TG) of the omega-3 fatty acid;
wherein the TG of the omega-3 fatty acid content in the composition is less than 80% of the total glycerides.

2. The composition of claim 1, where the high HLB emulsifier is selected from the group consisting of TPGS, PTS, Polysorbates, PEG-40 Hydrogenated Castor Oil (Cremophor/Kolliphor RH 40), PEG-35 castor oil (Cremophor EL), Solutol HS-15 and sucrose esters, or mixtures thereof.

3. The composition of claim 1, where the marine oil has a DG content of 10-90% of the total glycerides.

4. The composition of claim 1, where the marine oil has MG content of 10-90% of the total glycerides.

5. The composition of claim 1, where the total marine oil content is 30% wt/wt or less of the mixture comprising the MG, the DG and the TG of the omega-3 fatty acid.

6. The composition of claim 1, where the omega-3 fatty acid content in the composition comprising the MG, the DG and the TG of the omega-3 fatty acid is 5-20% wt/wt.

7. The composition of claim 1, wherein the water content is between 30 and 70% wt/wt of total mixture.

8. The composition of claim 1, further comprising at least one additives selected from the group consisting of a water soluble reducing agent, a hydrophilic reducing agent, a radical scavenger, a lipophilic reducing agent, and a metal chelator, or a mixture thereof.

9. The composition of claim 8, where the water soluble reducing agent is selected from the group comprised of Vitamin C (Ascorbic Acid) and a Vitamin C salt.

10. The composition of claim 8, where the lipophilic reducing agent is selected from a group consisting of ascorbyl palmitate, Vitamin E and Vitamin E derivatives (alpha, beta, gamma and delta-tocopherols, and their mixtures (natural mixed tocopherols), tocotrienols, ubiquinol, quercitin, cyanidin, catechin, 6,7-dihydroxyflavone, 7,8-dihydroxyflavone, 7,8-dihydroxycumarin, carotinoids such as beta-carotene, phenols and polyphenols (e.g. Lignin), vanillin, BHA (tert-butyl-4-hydroxyanisole), BHT (2,6-di-tert-butyl-p-hydroxytoluene, propyl-, octyl- and dodecylgallate, TBHQ (tert-butyl-hydroquinone) and ethoxyquin (6-ethoxy-12-dihydro-2,2,4-trimethylquinoline).

11. The composition of claim 8, where the metal chelator is selected from the group consisting of EDTA, disodium EDTA, calcium disodium EDTA, pyrophosphates, (e.g. tetra-potassium pyrophosphate), Guardian Chelox L, citric acid and citric acid salts, or mixtures thereof.

12. The composition of claim 8, where the metal chelator is calcium disodium EDTA or Guardian Chelox L, where the hydrophilic reducing agent/radical scavenger is Vitamin C, and the lipophilic reducing agent/radical scavenger is a natural mixed tocopherol blend with high gamma, and delta tocopherol content.

13. A method for the preparation of a stable, aqueous omega-3 fatty acid composition comprising:
a) water;
b) a high HLB non-ionic emulsifier with HLB>10; and
c) a marine oil, an algae derived oil or a vegetable oil high in omega-3 fatty acid comprising a total glycerides comprising a monoglyceride (MG), a diglyceride (DG) and a triglyceride (TG) of the omega-3 fatty acid,
wherein the TG of the omega-3 fatty acid content in the composition is less than 80% of the total glycerides;
the method comprising:
1) combining a mixture of omega-3 MGs, DGs and TGs comprising at least 20% of MGs and DGs derived from a purification or reconstitution refinement process of marine derived omega-3 with the high HLB non-ionic emulsifier to form a mixture; and
2) adding the non-ionic emulsifier to the mixture to form the stable composition.

14. The method of claim 13, wherein the TG of the omega-3 fatty acid content in the composition is less than 50%, 40%, 30% or 20% of the total glycerides.

15. The method of claim 13, wherein the water content is between 30 and 70% wt/wt of total mixture.

16. The method of claim 13, wherein the method further comprising the addition of at least one additives selected from the group consisting of a water soluble reducing agent, a hydrophilic reducing agent, a radical scavenger, a lipophilic reducing agent, and a metal chelator, or a mixture thereof.

17. The method of claim 13, wherein the omega-3 is omega-3 comprising EPA and DHA.

18. The method of claim 13, wherein the omega-3 fatty acid is a marine oil derived omega-3 fatty acid.
